(19) United States
(12) Patent Application Publication
(10) Pub. No.: US 2024/0146500 A1
(43) Pub. Date: May 2, 2024

(54) METHOD AND APPARATUS FOR RECONFIGURABLE CLOCK DATA RECOVERY IN FADING ENVIRONMENTS

(71) Applicants: Sundar Krishnamurthy, Dublin, CA (US); Deepak Dasalukunte, Beaverton, OR (US); Conor O'Keeffe, Cork (IE); Finbarr O'Regan, Innishannon, Cork (IE); Amy Whitcombe, Saratoga, CA (US)

(72) Inventors: Sundar Krishnamurthy, Dublin, CA (US); Deepak Dasalukunte, Beaverton, OR (US); Conor O'Keeffe, Cork (IE); Finbarr O'Regan, Innishannon, Cork (IE); Amy Whitcombe, Saratoga, CA (US)

(21) Appl. No.: 17/978,582

(22) Filed: Nov. 1, 2022

(51) Int. Cl. H04L 7/00; H04B 10/079; H04B 10/118; H04L 7/033; H04L 7/04

(52) U.S. Cl. CPC H04L 7/0075; H04B 10/07955; H04B 10/118; H04L 7/0029; H04L 7/0331; H04L 7/048

(57) ABSTRACT

A clock data recovery (CDR) apparatus can include an interpolator circuitry to interpolate an input received signal and to generate an output signal removing the sampling clock offsets. The apparatus can include timing error detector (TED) circuitry coupled to process the output signal and to provide a timing error as feedback to the interpolator circuitry, the timing error being adjusted by gain factors used in at least one of an automatic gain control (AGC) circuitry and an orthogonalization circuitry. The apparatus can include loop filter (LF) circuitry to filter the timing error to remove noise effects. The apparatus can include numerically controlled oscillator (NCO) circuitry to adjust for a basepoint and fractional interval used to adjust resampling coefficients within the interpolator circuitry.

### STATEMENT OF GOVERNMENT INTEREST

This invention was made with government support under Agreement HR00112290040 awarded by Defense Advanced Research Projects Agency (DARPA). The government has certain rights in the invention.

### TECHNICAL FIELD

Aspects pertain to wireless and optical communications. In particular, aspects relate to inter-satellite optical communications.

### BACKGROUND

Inter satellite optical links are designed between various satellites in low earth orbits (LEO) and Geo-stationary earth orbits (GEO) to enable ubiquitous connectivity around the world. Satellites travel at high relative velocity with respect to one another and with respect to communications devices (whether mobile or stationary) on the earth's surface with respect to moving objects in the atmosphere or space. This can lead to large Doppler shifts and sampling clock offsets in the communication signal between multiple satellites and between satellites and devices on the surface of the earth. Coherent optical systems enable high data rate links at 100 Giga bits per second (Gbps) or higher, but such terrestrial solutions are not prone to high Doppler shifts and clock offsets. Therefore, transceivers designed for fiber optic systems cannot be directly adopted in satellite systems. There is a growing need to efficiently mitigate the effect of large Doppler shifts and sampling clock offsets for satellite communications in both optical and wireless systems.

### BRIEF DESCRIPTION OF THE DRAWINGS

FIG. 1 is an exemplary block diagram of a wireless communication system that can include satellite communication systems in accordance with some aspects.

FIG. 2 illustrates a functional block diagram of coherent optical transceiver circuitry in accordance with some aspects.

FIG. 3 illustrates a coherent optical receiver architecture in accordance with some aspects.

FIG. 4 illustrates a receiver chain including clock data recovery (CDR) circuitry in accordance with some aspects.

FIG. 5 illustrates a clock data recovery scheme in accordance with some aspects.

FIG. 6 illustrates sampling clock adjustment as can be performed according to some example aspects.

FIG. 7 illustrates a method for CDR in accordance with some aspects.

FIG. 8A illustrates a loop filter in accordance with some aspects.

FIG. 8B illustrates a loop filter in accordance with other aspects.

FIG. 9 illustrates Doppler estimation blocks according to some aspects.

FIG. 10 illustrates a block diagram of a compute device in accordance with some aspects.

FIG. 11 illustrates a configurable averaging window according to some example aspects.

FIG. 12 is a block diagram of a power meter according to some aspects.

FIG. 13 is a block diagram of a programmable power meter 1300 according to some examples.

FIG. 14 illustrates a block diagram of a computing device that can be included in various example aspects.

### DETAILED DESCRIPTION

The following description and the drawings sufficiently illustrate specific aspects to enable those skilled in the art to practice them. Other aspects may incorporate structural, logical, electrical, process, and other changes. Portions and features of some aspects may be included in, or substituted for, those of other aspects. Aspects set forth in the claims encompass all available equivalents of those claims.

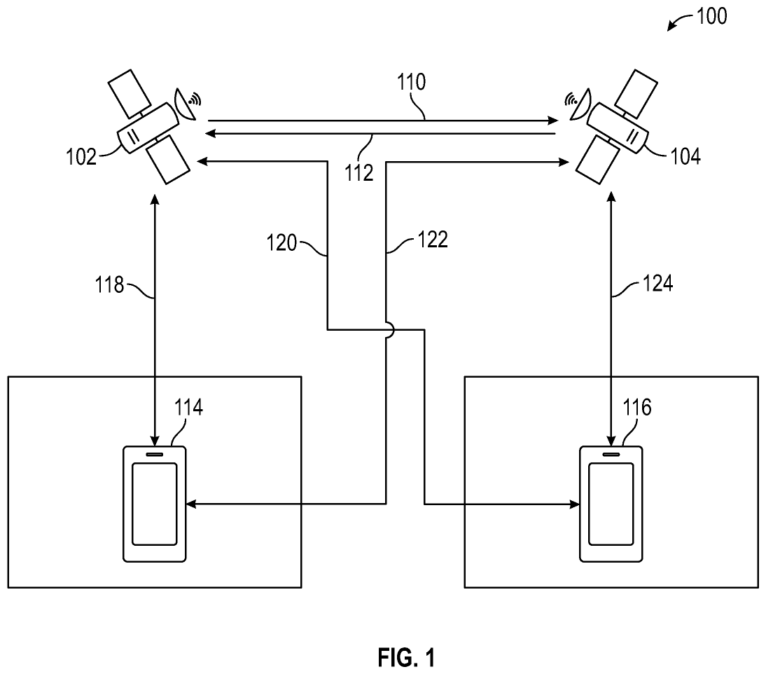

FIG. 1 is a block diagram of a wireless communication system 100 that can include satellite communication systems in accordance with some aspects. The system 100 can include two or more satellites 102, 104. While two satellites 102, 104 are shown, the wireless communication system 100 can include any number of satellites or other communications devices. The communication links between the satellites could be established based on optical links using coherent optical transceivers. The satellites 102, 104 can be located, for example, at a geostationary or non-geostationary orbital location. Where a satellite 102, 104 is in a non-geostationary orbit, the satellite 102, 104 may be a low earth orbit (LEO) satellite. Satellite 102, 104 may be communicatively coupled to subscribers 114, 116. The term subscriber terminals may be used to refer to a single subscriber terminal or multiple subscriber terminals. A subscriber terminal 114, 116 is adapted for communication with the satellite 102, 104. Subscriber terminals may include fixed and mobile subscriber terminals including, but not limited to, a cellular telephone, a wireless handset, a wireless modem, a data transceiver, a paging or position determination receiver, or mobile radio-telephone, or a headend of an isolated local network. A subscriber terminal 114, 116 may be hand-held, portable (including vehicle-mounted installations for cars, trucks, boats, trains, planes, etc.) or fixed as desired. A subscriber terminal 114, 116 may be referred to as a wireless communication device, a mobile station, a mobile wireless unit, a user, a subscriber, or a mobile. Where the communication platform of a wireless communication system is a satellite, the wireless communication system can be referred to more specifically as a satellite communication system. In accordance with certain embodiments, it is possible that a subscriber terminal 114, 116 with which one satellite 102, 104 wirelessly communicates is on a platform of or on another satellite.

Subscriber terminals 114, 116 and satellite 102, 104 communicate over beams 118, 120, 122, 124. For example, FIG. 1 shows beams 118, 120, 122, 124 for illuminating regions 126 and 128 having subscriber terminals therein. In many embodiments, the communication system will include more than four beams (e.g., sixty, one hundred, etc.). Each beam 118, 120, 122, 124 can have an uplink and a downlink. Although FIG. 1 only shows two subscriber terminals 114, 116 within each region 126, 128, a typical system may have thousands of subscriber terminals within each region 126, 128. In the embodiments described herein, it is assumed that the service beams (both downlink and uplink) are RF beams, as opposed to optical beams.

Either or both satellite 102, 104 can comprise a spacecraft and one or more payloads (e.g., the communication payload, an imaging payload, etc.). The satellite 102, 104 may also include a command and data handling system and multiple power sources, such as batteries, solar panels, and one or more propulsion systems, for operating the spacecraft and the payload. The command and data handling system can be used, e.g., to control aspects of a payload and/or a propulsion system but is not limited thereto.

The Sixth Generation (6G) wireless communication networks are expected to integrate various terrestrial, aerial and satellite networks into a reliable, high throughput network supporting massive number of devices. In particular, satellite communication enables connectivity to numerous terrestrial and maritime regions where it has been difficult for cellular networks to reach and provide high quality of service. Numerous satellite constellations have been deployed in various LEO orbits that have enabled distribution of connectivity service without the costs associated with cellular network infrastructure.

Most of these commercial LEO satellite constellations and various government LEO or Geo-stationary earth orbit (GEO) constellations are highly fragmented making it difficult for networks to route information efficiently. Methods and apparatuses according to aspects seek to bridge various LEO-LEO and LEO-GEO satellite constellations through optical inter-satellite links with a reconfigurable modem design with low size, weight, power and cost metrics (SWAP-C).

Each satellite 102, 104 can communicate with other satellites (e.g., each other or other satellites not shown in FIG. 1) over respective inter-satellite link (ISL) beams 110, 112. For example, the satellite 102 can send data to the satellite 104 over the ISL beam 110 and can receive data from the satellite 104 over the ISL beam 112. LEO and GEO satellites orbit the earth at a high velocity to escape the earth's gravitational pull. Different LEO and GEO satellites in various constellations experience high relative velocity with respect to one another. This leads to a wide range of Doppler shifts in the communication signal between various LEO-LEO and LEO-GEO satellites. Shifts can also occur in communication signals between LEO and GEO satellites and objects on the surface of the earth, for example mobile and stationary user devices, military devices, etc.

As a result of these Doppler shifts, signal bandwidth is impacted in the form of sampling clock offsets between the transmit and the receive satellites. Optical inter-satellite links involve complex pointing, acquisition and tracking (PAT) schemes wherein the receiver adjusts the aperture so that the optical beam is aligned and the intensity of the received signal is maximized. However, there is pointing jitter due to the satellite vibration, which leads to dynamic pointing induced fading. This poses unique challenges in the Clock and Data Recovery (CDR) schemes, as the intensity fluctuations in the form of block fading can result in CDR schemes losing the lock and necessitates careful CDR design.

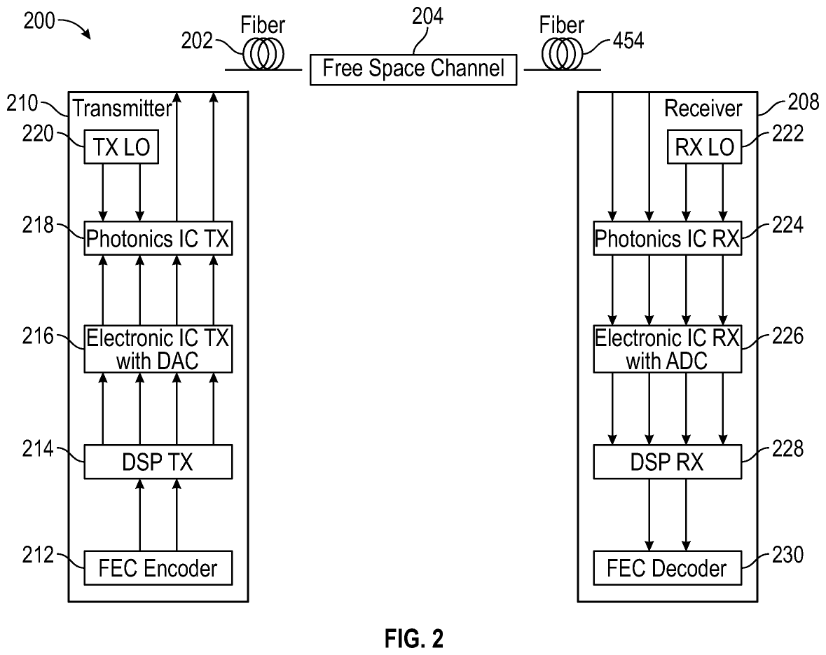

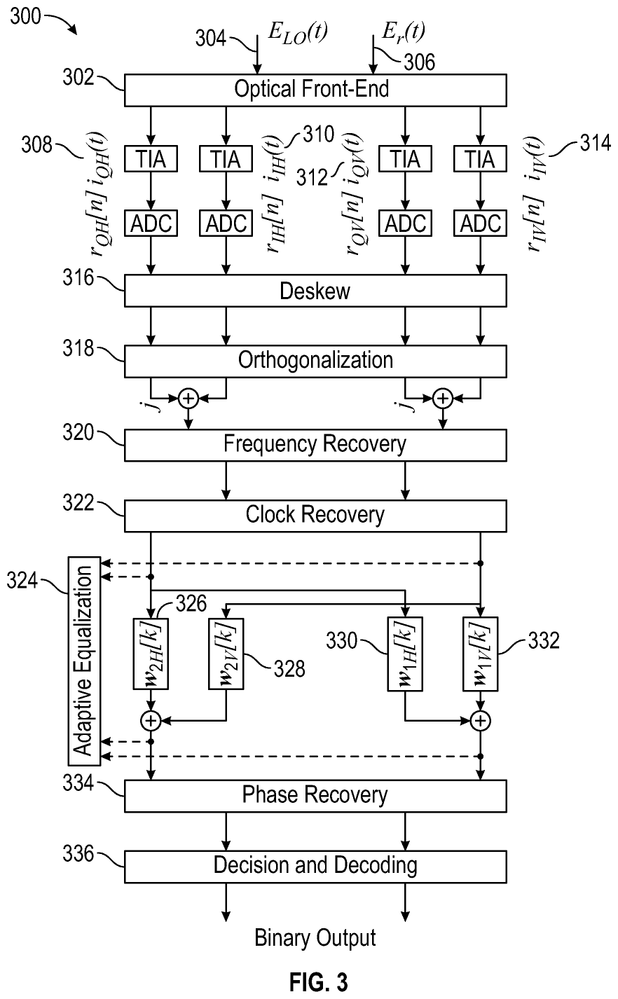

Aspects of the disclosure provide CDR schemes that are robust even in such a block fading environment with widely varying sampling clock offsets. A CDR scheme in accordance with various aspects of the disclosure can be based upon, for example, a Feedback Digital Phase Locked Loop (D-PLL) structure with an interpolator, a timing error detector (TED), a loop filter and a numerically controlled oscillator (NCO) as described later herein. Transceivers and architectures in which example aspects can be implemented are explained with reference to FIG. 2 and FIG. 3.

FIG. 2 illustrates a functional block diagram of a coherent optical transceiver circuitry 200 in accordance with some aspects. The coherent optical transceiver circuitry 200 includes a transmit fiber 202 connecting the transmitter modem to an optical aperture, which transmits an optical signal over a free space channel 204, and a receiver fiber 206 forwards the signal from a receiver optical aperture to the receiver modem 208. A transmitter 210 includes a Forward Error Correction (FEC) encoder 212 to encode a bit stream, digital signal processing (DSP) circuitry 214 to frame, modulate and generate the transmit waveform, transmitter electronics (EIC) circuitry 216 to convert a digital signal to an analog signal, transmitter photonics (PIC) circuitry 218 to convert the electrical signal to optical signal, and laser source circuitry 220 to generate an optical signal. Receiver circuitry 208 includes laser source 222 to coherently combine the received optical signal, receiver photonics circuitry (PIC) 224 to convert a received optical signal to an electrical signal, receiver electronics circuitry (EIC) 226 to convert an analog signal to a digital signal, digital signal processing circuitry 228 to correct impairments and demodulate the bits and a FEC decoder circuitry 230 to decode a bit stream.

FIG. 3 illustrates a coherent optical receiver architecture 300 in accordance with some aspects. Optical front-end 302 is part of the photonics circuitry that mixes the received optical signal 304, 306 with local oscillator (LO) signal at a certain frequency. Optical front-end 302 can provide electrical outputs after photodetection 308, 310, 312, 314 representing the in-phase and quadrature components for two polarizations to the Trans-impedance Amplifiers (TIA). Outputs of TIA are converted from Analog to digital using the ADC. Outputs 308, 310, 312, 314 can be provided to a deskew block 316 to correct the skew mismatches across the 4 streams. Outputs of the deskew block 316 can be provided to an orthogonalization block 318 to orthogonalize the in-phase and quadrature components. Orthogonalization block 318 can provide outputs to frequency recovery 320 to track and correct the Doppler shifts in the received signal. Frequency recovery 320 can provide outputs to clock recovery 322 to correct the sampling clock offsets in the received signal. Clock recovery 322 is described in more detail later herein.

Adaptive equalization 324 can then be performed and blocks 326, 328, 330 and 332 can equalize the dual polarization received signal and remove inter-symbol interference or dispersion and provide output to phase recovery 334. Phase recovery 334 can correct for the phase noise, estimate the carrier phase and provide output to decision and decoding 336. Decision and decoding 336 can demodulate the signal to provide binary output and soft decisions.

Aspects of the disclosure use various gain factors obtainable from, for example, digital signal processing (DSP) circuitry of a device (e.g., satellite or other mobile device) to deduce the fading levels as briefly mentioned earlier herein, and used to scale the timing error detector output in the CDR. This ensures that the noise due to fading does not affect the CDR and a signal lock can be maintained despite the fades. Further, a TED is chosen to be robust against fading, e.g., Modified Gardner TED or Amplitude directed TED, with different complexity. The order of the loop filter (LF) can be adapted to tradeoff between fast acquisition and jitter performance. Further, filtered error signal from the adaptive equalizer is fed back to the CDR as a noise measure and used to adapt various loop-filter parameters. Aforementioned CDR techniques are also made reconfigurable to support various M-ary phase shift keying (M-PSK) modulation schemes such as differential phase shift keying (DPSK), binary phase shift keying (BPSK) and quadrature phase shift keying (QPSK). Similar reconfigurable techniques can be used in the Edge detection based CDR for on-off keying (OOK) and pulse-position modulation (PPM) modulation schemes based on the signal power correlation, while ensuring robustness against fading.

Regarding properties of pointing jitter, the Probability Density Function (PDF) of the pointing errors with random root mean square (rms) jitter is found to be a Nakagami-Rice distribution defined for certain pointing and bias angles. This reduces to a Rayleigh distribution when bias angle is 0, e.g., when there is no boresight. Optical intensity can then be modeled as a beta distribution using a function of the beam divergence and the pointing jitter. Typical satellite vibration could be 100 Hz and that roughly corresponds to one millisecond (ms) channel coherence time considering beam divergence and pointing jitter. This leads to a block fading environment as the coherence time is close to a millisecond, while the frame duration in available currently-used optical standards may be at most a few microseconds or even less.

LEO and GEO satellites in various constellations move at a high velocity to escape the gravitational pull of the earth and stay in orbit. As a result, there is high relative velocity between most pairs of satellites which leads to a Doppler shift in the communication signal. In addition, this results in bandwidth mismatch between the satellites that manifests as a sampling clock offset between the transmitter and the receiver. Due to the orbital motion of the satellites, there can be up to +/−50 ppm sampling clock offset between the transmitter and the receiver. In addition, clock inaccuracies at the transmitter and the receiver can contribute to additional +/−20 ppm clock offset as suggested in the OpenZR+ standard. In the absence of a proper correction mechanism, severe signal to noise ratio (SNR) degradation can occur due to the bandwidth mismatch between the transmitter and the receiver. Therefore, CDR functionality according to aspects can be expected to correct for up to +/−70 ppm sampling clock offsets based on a closed loop feedback scheme. In an example maximum signal bandwidth of 33 GHz provided in some satellite systems or other communication systems, this 70 ppm translates to 2.31 MHz sampling clock offset. Correcting this sampling clock offset in the presence of dynamic pointing induced fading is one of the key challenges for optical ISLs.

### Methods and Circuitry for Clock Data Recovery

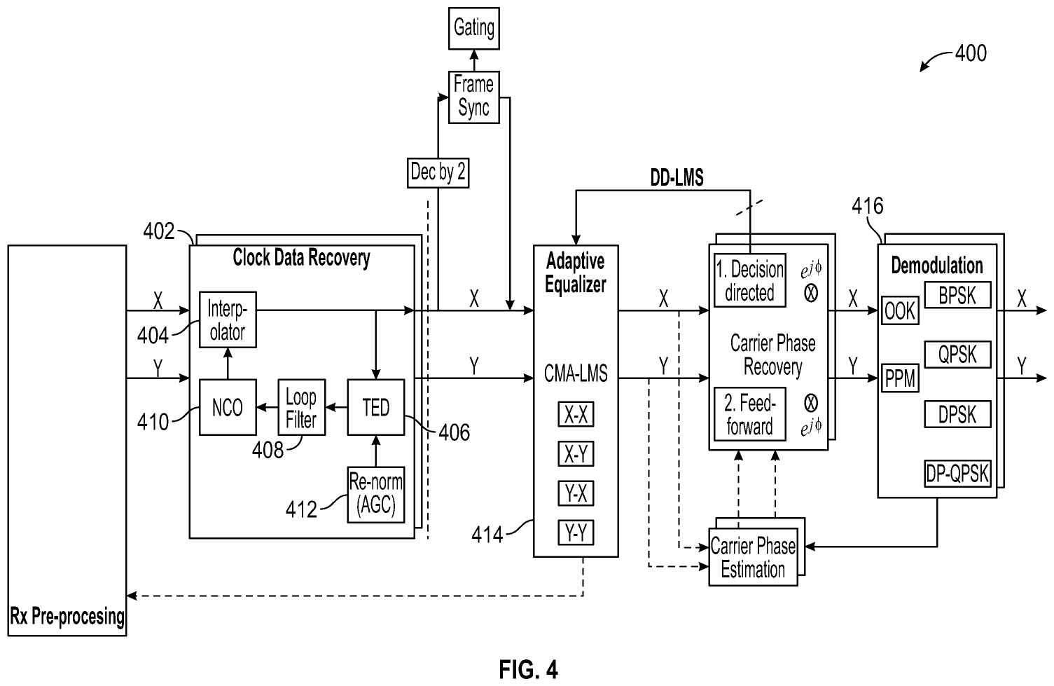

FIG. 4 illustrates a receiver chain 400 including clock data recovery (CDR) 402 circuitry in accordance with some aspects. Similar to terrestrial coherent optical systems, feedback clock recovery schemes can be used to correct the sampling clock offsets of <100 ppm. Feedback clock recovery schemes can be built using a Digital Phase Locked Loop (D-PLL) structure, with timing error deduced based on Gardner methods that offers a low complexity design with two samples per symbol. Feedback clock recovery schemes can incorporate a cubic interpolator 404 with a Farrow structure on the main path. The interpolator 404 output can be fed to a Timing error detector (TED) 406, which can be chosen based on the Modified Gardner or amplitude-directed methods of sampling phase error detection. Timing error or sampling phase error can then be filtered with a loop filter 408 with proportional and integral arms. This loop filter 408 also provides robustness against phase noise which is uncompensated at this stage.

A Numerically Controlled Oscillator (NCO) 410 can adjust for the fractional interval from the basepoint, to adjust for the sampling phase offset. CDR can be performed at 2× baud rate before the adaptive equalizer for M-PSK modulation schemes. T/2 spaced samples from the Lagrange interpolator or decimator can be processed by a CDR block 402 to obtain the symbol timing and adjust for sampling clock offsets.

Feedback Automatic Gain Control (AGC) 412 can be performed in, for example, digital signal processing (DSP) circuitry to account for the received power fluctuations and provide a tracking bandwidth so that the converter circuitry or other circuitry (e.g., analog-to-digital converters (ADCs)) can adjust the gains and optimize dynamic ranges. AGC 412 can deduce the fading level in a block fading environment effectively, since other systems or circuitry such as power meters do not provide tracking bandwidth which could be a concern with abrupt signal level fluctuations. Further, in coherent optical systems, an orthogonalization procedure (e.g., Gram-Schmidt orthogonalization procedure—GSOP) can be performed to orthogonalize the I,Q components. This operation can also scale the signal power to unity which is beneficial for fixed point design for downstream receiver circuitry. It can be noted that after the GSOP procedure, a signal during a fade may be dominated by noise despite the power being unity.

In the presence of fading due to pointing jitter, the sampling phase error cannot be identified correctly due to fluctuating signal level. Therefore, AGC gain factors used are fed to the TED 406 along with GSOP scaling factors, so that the TED 406 can adjust for the right signal level before calculating the timing error metric. Further, in the presence of fading due to pointing jitter, a high amount of noise can be injected into the CDR 402 during deep fades and make the CDR 402 lose lock on the signal. It is therefore important that the CDR 402 operations with high noise do not impact the behavior of the CDR 402 when the noise is low. Exemplary aspects can help ensure this by scaling the TED 406 output with the fading level deduced from the AGC 412 and the GSOP gain factors. CDR 402 can track the symbol transitions but is often limited by noise that worsens in a block fading environment. Accordingly, CDR 402 design according to aspects is directed to maximizing the effective SNR at the input of the adaptive equalizer 414.

Using any of the systems, algorithms and circuitry described herein, clock data recovery can be performed with robustness to pointing induced block fading, prevalent in optical ISLs.

AGC 412 and GSOP scale factors can be used to scale the TED 406 output, so that higher noise due to signal fades doesn't impact the CDR 402. An amplitude directed TED or Modified Gardner TED 406 can be chosen from the Gardner family based on the sign or power in the received signal and adjusted to provide robustness in fading. Loop filter 408 bandwidth can be configured based on a filtered noise measure using the adaptive equalizer 414 output, and various loop filter 408 parameters can be deduced from this bandwidth.

Loop filter 408 can adapt between two operational modes of first order and second order by turning off an associated integrator as described in more detail later herein. Towards reconfigurability, in the case of OOK & PPM modulation schemes according to a Space Development Agency (SDA) standard, an edge detection based symbol timing detection can be performed using a demodulator 416 output. This can be performed based on power calculation over all the samples and correlation to identify the symbol edges. Gating can be supported in various blocks of a receiver chain before the CDR 402 so that burst mode waveforms can be supported and noise from the front end does not impact the CDR 402.

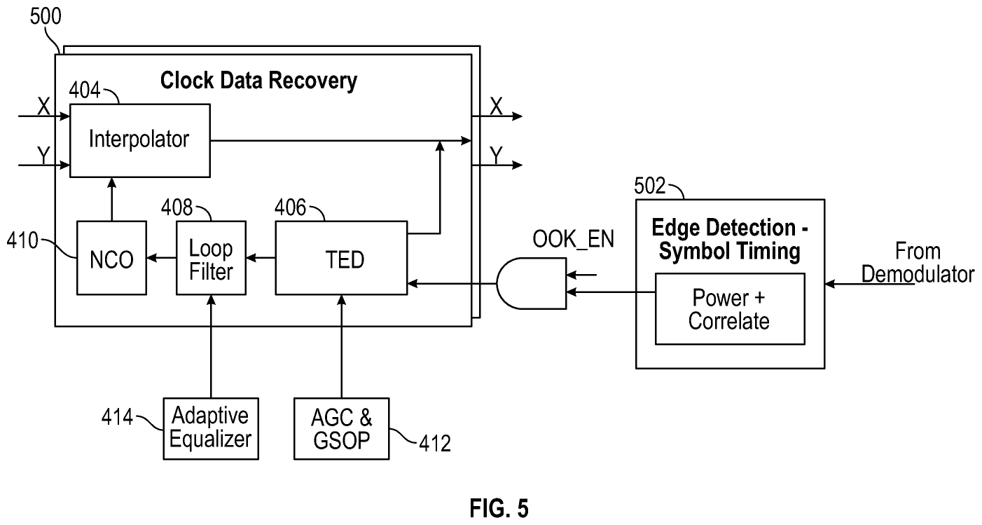

FIG. 5 illustrates a clock data recovery 500 scheme in accordance with some aspects. The clock recovery scheme shown in FIG. 5 can be used, for example, for M-PSK, OOK and PPM modulation schemes. AGC gain and GSOP scale factors 502 can be buffered based on a fixed latency of blocks between the GSOP 502 and the CDR 500. These values are then used to adjust a timing error metric within the TED circuitry 504. Noise measure from the adaptive equalizer 506 can be filtered and used to configure the loop bandwidth and various loop filter 408 parameters.

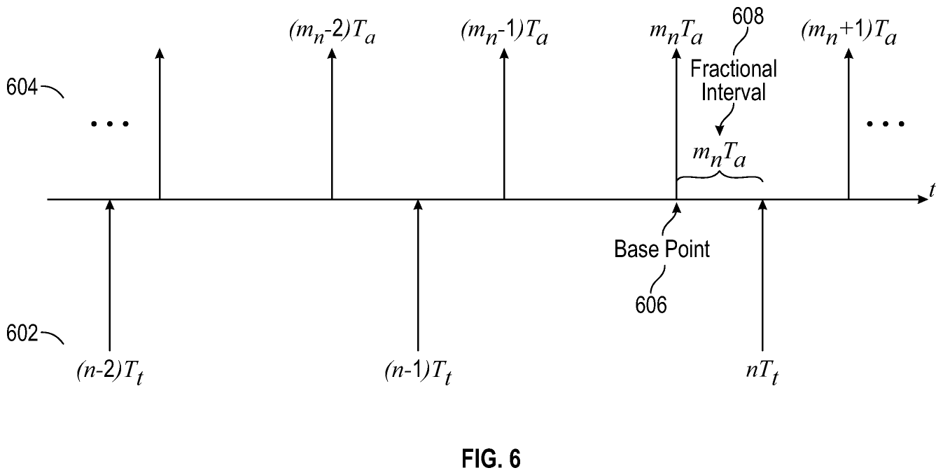

FIG. 6 illustrates sampling clock adjustment as can be performed according to some example aspects. Original sampling instants Tₐ are shown at 604, whereas the sample period with clock offset Tₜ is shown in the sampling instants at 602. Continuous correction of the sampling phase offset can help reduce or eliminate the sampling clock offset and recover the signal with the proper bandwidth.

For each symbol, basepoint 606 is defined as mₙTₐ and the fractional interval 608 μₙTₐ is identified and adjusted in order to resample to the optimum sampling instant t or Tₜ according to Equation (1)

t=mₙTₐ+μₙTₐ (1)

Sampling phase adjustment then involves calculation of this fractional interval and continuous adjustment is performed for each sample.

### Interpolator

Referring again to FIG. 5, as mentioned earlier herein, an interpolator 404 (e.g., a cubic interpolator) can provide inputs to TED circuitry. An example cubic interpolator 404 can use four tap coefficients for each sample. Because μₙ is calculated as one of the outputs of the NCO 410, various powers can be pre-computed, i.e., μₙ, μₙ², μₙ³ can be calculated using multiplications or lookup tables. For example, the interpolator 404 can calculate four tap Lagrange coefficients for resampling (e.g., for multiplying with received signals), according to Equations (2)-(5):

$${w}_{n - 2} = - \frac{1}{6} {μ}_{n}^{3} + \frac{1}{6} {μ}_{n} \qquad ( 2 )$$

$${w}_{n - 1} = \frac{1}{2} {μ}_{n}^{3} + \frac{1}{2} {μ}_{n}^{2} - {μ}_{n} \qquad ( 3 )$$

$${w}_{n} = - \frac{1}{2} {μ}_{n}^{3} - {μ}_{n}^{2} + \frac{1}{2} {μ}_{n} + 1 \qquad ( 4 )$$

$${w}_{n + 1} = \frac{1}{6} {μ}_{n}^{3} + \frac{1}{2} {μ}_{n}^{2} + \frac{1}{3} {μ}_{n} \qquad ( 5 )$$

Note that both the input and the output of the interpolator 404 can be defined for two samples per symbol, and the operations can be parallelized for multiple samples as necessary. Lagrange interpolation reduces to only 12 multiplications or look up table queries and few additions for computing the interpolated signal. This interpolator 404 according to aspects can be used with different root-raised-cosine (RRC) filter roll-off factors, for example in the range of about 0.05-1.

### Timing Error Detector (TED)

Still with reference to FIG. 5, interpolator 404 output can be provided to TED circuitry 406 for calculating a timing error metric. In some examples, a Modified Gardner TED can be chosen that calculates the energy in T/2 spaced symbols of an input signal. A timing error using Modified Gardner TED based on power can be given as:

e(k)=K_{f}|yₙ₋₁|²(|yₙ₋₂|²−|yₙ|²) n=2k (6)

In Equation (6), yₙ denotes the signal after interpolation at current sample index ‘n’ while yₙ₋₁, yₙ₋₂ denote the signal in previous 2 sample indices and k is used to define the symbol index with 2× oversampling factor. In one key aspect of the disclosure, K_{f} denotes the dynamic scaling of the TED output that considers AGC gains and GSOP factors for enhancing robustness against fading and could be designed based on lookup tables. This scaling ensures that during fades, timing error is weighted appropriately (low) such that sampling phase lock can be maintained, and CDR can flywheel through the fades. It can be noted from Equation (6) that calculating timing error involves 8 real multiplications and one addition per sample and, because Gardner TED is derived from the Maximum Likelihood principle, the TED 504 as described above can provide improved performance.

In one aspect of the disclosure, an amplitude-directed TED can be used in the CDR according to Equation (7) that is robust against fading:

e(k)=K_{f} Re{y*ₙ₋₁(sign(yₙ₋₂)−sign(yₙ))} n=2k (7)

where, sign denotes the signum function (i.e., sign(y)=y/|y|) and is used to remove the amplitude from the complex value, while Re{ } denotes the real part of the argument. In Equation (7), the terms yₙ, yₙ₋₁, yₙ₋₂, k, K_{f} are used to denote similar parameters as those in Equation (6). Equation (7) includes a greater number of computations than Equation (6) involving lookup tables but can provide improved performance in fading environments. In either case (Equation (6) or Equation (7)), TED circuitry 406 can operate in the presence of phase noise and therefore, CDR 500 can be performed before the adaptive equalizer 414 (FIG. 4).

Edge detection based TED 406 can be used for OOK/PPM waveforms wherein the center or the edge of the symbol period is identified using symbol decision feedback. In at least these aspects, circuitry 502 can oversample (e.g., samples can be 4× or 5× oversampled), and power calculation and correlation with symbol decisions can be performed for those 4 or 5 samples per symbol. This helps in centering the symbol by identifying the symbol boundaries through power correlation. This would be similar in principle to an early-late clock recovery mechanism, but also considers appropriate sampling for various pulse widths and shapes, especially in the case of M-ary PPM waveforms with M=2, 4, 8, 16.

AGC gain and GSOP scaling factors 412 can be provided to handle fading losses due to pointing errors, and according block 412 can be provided to revise TED 406 timing error metric. This is because due to intensity fluctuations, signal is no longer near constant envelope and further CDR can lose lock on the sampling phase. AGC gain measured in the receiver front-end and GSOP scaling factors are buffered based on the measured latency and applied as a TED correction factor K_{f} in Equations (6) and (7). GSOP scale factors can be inverted to obtain the signal level before IQ correction. Then, the AGC gains can be provided to rescale so that fades do not affect the CDR 500 lock on the sampling phase. AGC bandwidth can help prevent sudden power fluctuations from affecting circuitry, e.g., phase locked loop (PLL) within the CDR 500. Stability of the CDR 500 and jitter performance can be evaluated, and loop filters configured appropriately based on the TED 406 used.

In other aspects of the disclosure, timing error can be calculated by the TED 406 using the equalizer 414 output, which is at the baud rate of the input signal. This can improve the performance for channels with dispersion, especially for dual polarization. At least these examples may be better suited in a least mean square (LMS) mode of equalizer in the steady state, while in an initial constant modulus algorithm (CMA) mode it may be more suitable to provide an equalizer input signal at the TED 406. In either of the two aspects, NCO 410 and interpolator 404 can operate before the equalizer 414 and adjust for the sampling phase.

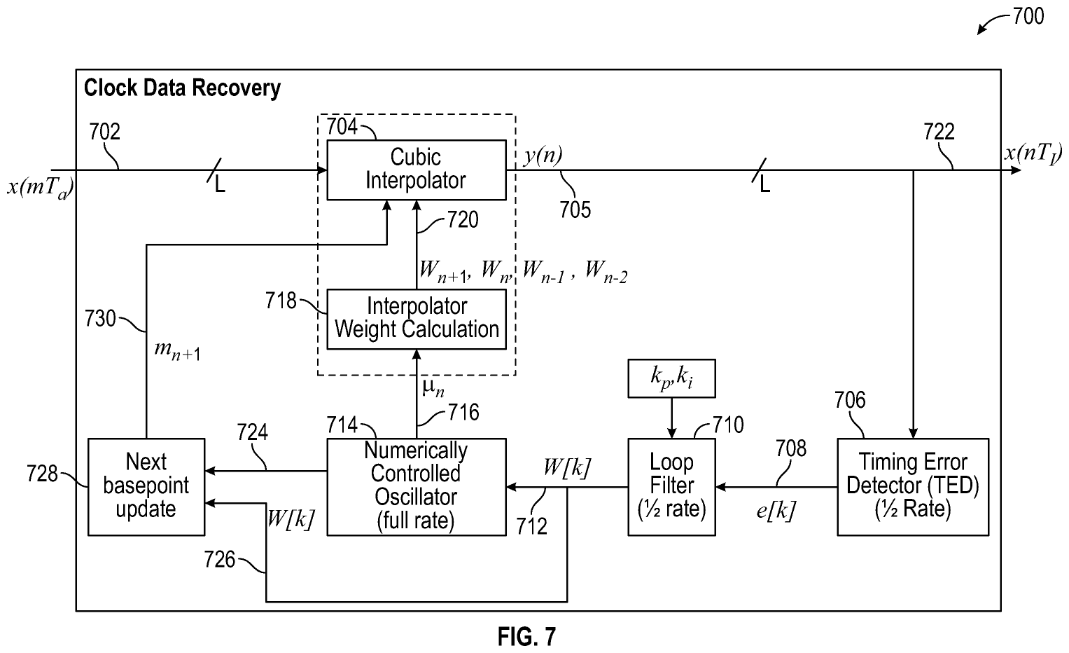

FIG. 7 illustrates a method 700 for CDR in accordance with some aspects. Calculations described above with reference to FIG. 1-6 can be applied to any of the operations described in method 700.

At 702, an input signal is provided to interpolator 704, where is defined as a sampling period of an ADC providing the input 702, and m is used to define the basepoint. An output 705 of the interpolator 704 can be provided to TED circuitry 706. TED circuitry 706 can provide an output 708, e.g., according to Equations (6) and (7) although aspects are not limited to those two equations for calculating the output 708.

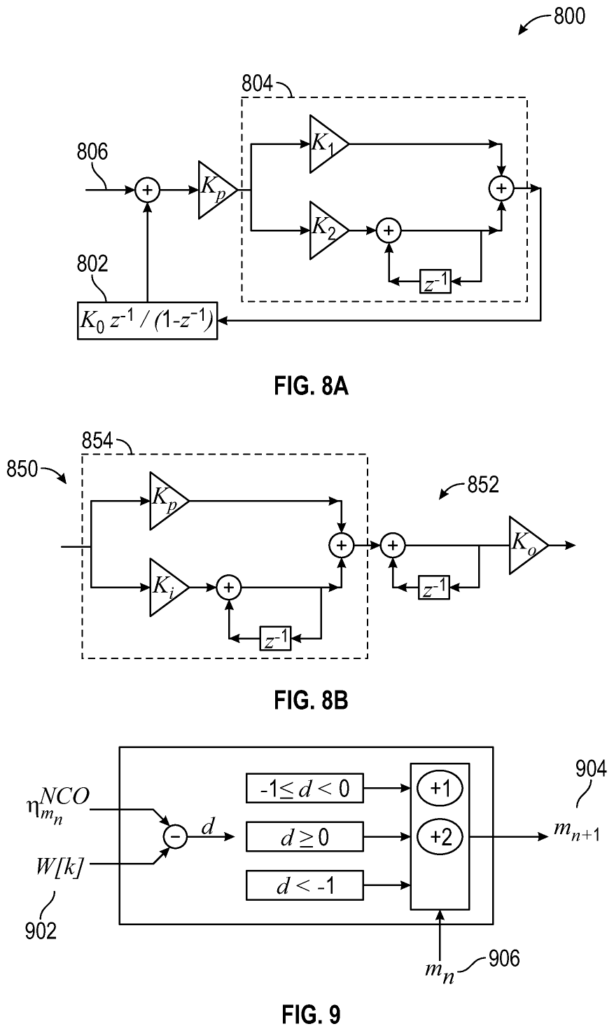

Output 708 is provided to a loop filter at 710, wherein the loop filter 710 is described in more detail below with reference to FIGS. 8A and 8B. Loop filter 710 provides output 712 to NCO 714, wherein the output 712 corresponds to an output at the time of the input sample mₙ. The NCO 714 is described in more detail later herein with reference to FIG. 9. The NCO 714 provides output 716 to an interpolator weight calculation 718, where the output 716 represents a fractional interval as described in further detail with respect to FIG. 9. The interpolator weight calculation provides weights as inputs 720 to interpolator 704 and the interpolator provides output 722, wherein T₁ is the sampling period of the interpolator 704. The NCO 714 and loop filter 710 further provide inputs 724, 726 to update a basepoint update circuitry 728 wherein the inputs 724, 726 are described in more detail with reference to FIG. 8A, FIG. 8B and FIG. 9 below and the basepoint update circuitry 728 provides input 730 to the interpolator 704.

### Loop Filter

The measured timing error metric (e.g., as output by TED 706 in FIG. 7) may suffer from phase noise due to laser linewidth as well as noise due to dynamic pointing induced fading. Accordingly, a loop filter can be provided to filter out at least one or both types of noise. Both first and second order loop filters can be included or designed, and an adaptive logic can select one of the first or second order filter based on, for example, state of operation of the CDR or other circuitry. In an initial acquisition phase of circuitry (e.g., a digital PLL)), first order filters can be used because a first order filter can lock faster to the right sampling frequency relative to second order filters. On the other hand, a second order filter can be employed in the steady state after initial acquisition and can provide better jitter performance relative to first order filters.

FIG. 8A illustrates a loop filter 800 in accordance with some aspects and FIG. 8B illustrates a loop filter 850 in accordance with other aspects. The loop filter 800 displayed in FIG. 8A can include a second order loop filter but aspects are not limited thereto and the loop filter 800 can be configured as a first order loop filter by setting K₀=0 in 802 to generate the first order loop within block 804. A timing error input 806 is then filtered using the loop filter. The loop filter 850 displayed in FIG. 8B can include a second order loop filter but aspects are not limited thereto. In contrast to the loop filter 800, the loop filter 850 involves cascading two first order filters 852, 854 in a feed-forward structure, to form the second order loop filter. Various aspects in this disclosure are applicable to both loop filter structures and can be used interchangeably, with slight variations in the calculation of loop filter bandwidth and other loop parameters. The loop filter 850 can be configured as a first order filter during initial acquisition by turning off the cascaded second filter.

Methods and systems according to aspects can adaptively select a loop bandwidth B_{L} as a CDR parameter to handle varying noise levels. Various lookup tables can be provided to enable this adaptive selection. B_{L}Tₛ/N can be included as a design parameter and can be defined as the loop bandwidth normalized by the symbol baud rate, where Tₛ is the symbol period corresponding to the operating baud rate. N denotes the oversampling factor at the CDR and is defined for different modulation schemes. For example, N=2 for most M-PSK schemes in OpenZR and LCRD standards and 4 or 5 for OOK/PPM schemes of SDA standard. Loop bandwidth can be adaptively selected using a filtered value of the measured equalizer error metric. Adaptive tuning can reduce effects of pointing induced fading as the coherence time is typically in the range of 0.5-1 ms while the frame duration can be on the order of a few μs (e.g., 5-10 μs in OpenZR) in the case of high baud rates. An example B_{L}Tₛ value can be in the order of about 1e-4 and is based on the baud rate. Loop bandwidth B_{L} can be deduced and used to calculate other loop filter parameters. Natural frequency of the loop is a function of the loop bandwidth defined according to Equation (8):

$${ω}_{n} = \frac{8 {B}_{L} ζ}{1 + 4 {ζ}^{2}} \qquad ( 8 )$$

Damping factor ζ can be used to control the damping effect on the transient response. Damping factor ζ can be chosen in the range 0.5 to 5, and in example aspects will often be around 1 or 2 to ensure good transient and steady state performance. Proportional and integral arm gain factors can be calculated by setting K₀ to −1 for second order mode and 0 for the first order mode. Kₚ can be defined based on the TED sensitivity. In some examples, Kₚ can be based on slope of the timing error S-curve at the right sampling instant when value is 0. Since timing error exhibits a S-curve nature, slope at zero sampling instant is a good parameter to design the Digital PLL. Kₚ can be chosen based on the waveform, RRC rolloff and tabulated in lookup tables, for example. K₁ and K₂ can be calculated according to Equations (9) and (10).

$${K}_{p} {K}_{0} {K}_{1} = \frac{4 ζ \frac{B \text{?} T \text{?}}{N ( ζ + \text{?} )}}{1 + 2 ζ \frac{B \text{?} T \text{?}}{N ( ζ + \text{?} )} + {( \frac{B \text{?} T \text{?}}{N ( ζ + \text{?} )} )}^{2}} = \frac{4 ζ \frac{{ω}_{n}}{\text{?}}}{1 + 2 ζ \frac{{ω}_{n}}{\text{?}} + {( \frac{{ω}_{n}}{\text{?}} )}^{2}} \qquad ( 9 )$$

$${K}_{p} {K}_{0} {K}_{1} = \frac{4 {( \frac{B \text{?} T \text{?}}{N ( ζ + \text{?} )} )}^{2}}{1 + 2 ζ \frac{B \text{?} T \text{?}}{N ( ζ + \text{?} )} + {( \frac{B \text{?} T \text{?}}{N ( ζ + \text{?} )} )}^{2}} = \frac{4 {( \frac{{ω}_{n}}{\text{?}} )}^{2}}{1 + 2 ζ \frac{{ω}_{n}}{\text{?}} + {( \frac{{ω}_{n}}{\text{?}} )}^{2}} \qquad ( 10 )$$

$$\text{?} \text{indicates text missing or illegible when filed}$$

In Equations (9) and (10), natural frequency normalized by twice the sampling rate is used as the key loop filter parameter (ωₙ/2Fₛ) and is used to deduce the proportional and integral arm gains. Since the normalized loop bandwidth BLTS changes based on the filtered equalizer error function, all loop filter parameters are recalculated at a programmable interval based on the channel coherence time (e.g., 0.5-1 ms) and the rate of change of the state of polarization (e.g., 50 kilo radians per second).

While the above description is for a feedback structure of a second order loop filter in FIG. 8A, it can be noted that a second order loop filter can also be realized in a feed-forward manner by cascading a first order filter with proportional and integral arms with another first order filter as in FIG. 8B. Loop filter bandwidth and various parameters can be selected adaptively for such a second order filter in a similar manner.

A Digital-PLL (similar to the Digital-PLL mentioned earlier herein with reference to FIG. 4) can also be defined with a first order loop filter. Referring still to FIG. 8A, the loop filter can be comprised of a proportional arm and an integral arm with constants k₁=kₚ and k₂=kᵢ, where kₚ is a proportional constant and kᵢ is an integral constant. Loop filter output W[k] can then be represented as a function of the timing error metric from the TED e[k] according to Equation (11):

$$W [ k ] = e [ k ] {k}_{p} + {k}_{i} {\sum }_{l = 0}^{k -} \text{?} e [ k - l ] \qquad ( 11 )$$

$$\text{?} \text{indicates text missing or illegible when filed}$$

The two constants kₚ and kᵢ can be calculated based on the loop bandwidth B_{L}, natural loop frequency ωₙ, TED Sensitivity k_{d} and the Damping ratio ζ according to Equations (12) and (13):

$${k}_{p} = \frac{2 ζ}{\sqrt{{k}_{d} / {k}_{i}}} \qquad ( 12 )$$

$${k}_{i} = \frac{{ω}_{n}^{2}}{{k}_{d}} \qquad ( 13 )$$

Slope of the S-curve is given by the TED sensitivity k_{d}, which enhances and contributes to performance of the CDR described herein.

The loop filter according to example aspects can be unrolled as described below, and parallelism can be achieved for efficient hardware implementation.

In an initial operation, the summation of an n-tap filter (wherein n=4 in some examples, although examples are not limited thereto) can be unrolled according to Equation (14):

W[k]=e[k]*kₚ+kᵢ*(e[k]+e[k−1]+e[k−2]+e[k−3]+e[k−4]) (14)

The filter can be parallelized by N (given N=3 for purposes of illustration, although examples are not limited thereto) according to Equations (15)-(17):

W[3k]=e[3k]*kₚ+kᵢ*(e[3k]+e[3k−1]+e[3k−2]+e[3k−3]+e[3k−4]) (15)

W[3k+1]=e[3k+1]*kₚ+kᵢ*(e[3k+1]+e[3k]+e[3k−1]+e[3k−2]+e[3k−3]) (16)

W[3k+2]=e[3k+2]*kₚ+kᵢ*(e[3k+2]+e[3k+1]+e[3k]+e[3k−1]+e[3k−2]) (17)

Similar to the parallelization with unrolled loops of first order filter, second order loop filter could also be unrolled in order to process samples efficiently. This is applicable to both feed-back and feed-forward structures of the second order loop filter in FIGS. 8A and 8B, respectively.

In a key aspect of the disclosure, the loop filter bandwidth and other gain parameters can be deduced using a filtered equalizer error metric wherein the equalizer could be designed based on Constant Modulus Algorithm (CMA), Least Mean Squares (LMS), Radius Directed Equalizer (RDE), Feed-forward Equalizer (FFE) or Decision Feedback Equalizer (DFE). Filtering duration can be calculated based on the fade coherence time, e.g., 1 ms. Lookup tables could be used in order to select parameters while ensuring loop filter stability.

In another aspect of the disclosure, loop filter and TED parameters can be calculated adaptively based on lookup tables defined for each of the waveforms or modulation schemes such as M-ary Phase shift keying (M-PSK with M=1,2,4) or On-off keying (OOK) or M-ary Pulse position modulation (PPM with M=2, 4, 8, 16). This enables high reconfigurability for supporting various waveforms used in Optical inter-satellite links.

### Numerically Controlled Oscillator (NCO)

Referring to FIG. 6, a numerically controlled oscillator, e.g., NCO 714 (FIG. 7) or NCO 410 (FIG. 4), can adjust for the offset from the basepoint 606, also referred to as the fractional interval 608. This can be performed through a fractional μₙ calculation, as shown in Equations (18) and (19).

$${η}_{m}^{NCO} \text{?} = [ {η}_{{m}_{a} - 1}^{NCO} - {W [ k ]}_{mod - 1} \qquad ( 18 )$$

$${μ}_{n} \approx \frac{{η}_{{m}_{n}}^{NCO}}{W [ k ]} \qquad ( 19 )$$

$$\text{?} \text{indicates text missing or illegible when filed}$$

Once basepoint 606 is identified based on certain set of rules with parameters according to Equation (18)-(19) fractional μₙ can be calculated according to Equation (18)-(19) to adjust for the sampling phase. The set of rules can adjust the basepoint using current symbol, next symbol or 2 symbols later (delay of 0, 1, or 2) to adjust the sampling phase. In the normal NCO operation with zero or negligible clock offset, basepoint is shifted by 1 in the output for each input sample. However, in the presence of sampling clock offsets, occasional 0 shift or +2 shift to the basepoint would be present depending on the clock offset.

These zero and two shifts could lead to either less or more samples per clock cycle getting generated at the CDR, as compared to the number of samples defined at the nominal baud rate with 2× oversampling. For example, 47 or 49 samples could be generated occasionally as output per clock cycle while there are 48 parallel chains to consume the CDR output samples. Buffers and Queues/FIFOs (First In First Out) could be used to align the samples and forward appropriate number of samples (e.g., fixed 48) to the equalizer for baud rate signal processing.

A complete parallel implementation of the NCO 410, 714 can be performed to enable a more efficient hardware implementation. Both NCO and loop filter operations can be recursively expanded, and individual sample updates can be applied in parallel.

FIG. 9 is an illustration of the NCO operation according to some example aspects. In FIG. 9, sample indices are updated based on the calculated base point and the fractional interval. In the below equations, the division could be performed using a lookup table. Loop filter output 902 (e.g., filtered timing error metric W[k]) can be used to calculate the fractional interval adjustment with respect to the basepoint 904, 906 for each input sample.

In another aspect, sampling phase deduced at the CDR can be filtered with a first order recursive filter and fed back to an ADC circuitry to perform a fine adjustment of the sampling phase at the ADC. Sampling phase adjustment could enable a fine adjustment in the range of [ 1/30- 1/20] times the symbol period. This can improve performance as the effective SNR would be maximized by sampling at an appropriate instant in time.

When Doppler shift in the signal is known at a specific time, say +/−50 ppm, it can be used to constrain the sampling clock offsets. Since the clock inaccuracies are typically only +/−20 ppm, it can be combined with the Doppler shift to ascertain a bounding range for sampling clock offset between +/−[70-100] ppm. This can be deduced from the expected lock-in and pull-in ranges of the CDR or Digital PLL, which would be only few MHz for even 33 GBaud symbol rate. Various checks could be added in the TED, Loop filter and NCO in order to facilitate these constraints. This helps in increasing robustness against fading, by minimizing the impact of noise.

### Gating for Burst Mode Support

Referring back to FIG. 4, in addition to issues due to fading described above, a CDR can lose lock with burst mode or return to zero (RZ) waveforms in which only (or predominantly) front-end noise is present in the signal when no signal is transmitted. Functionalities prior to CDR 402 can be gated such that specific samples corresponding to dead time (no symbol transmission) are not processed at the CDR 402 and the adaptive equalizer 414. The gating methods can take effect at the sample level once frame synchronization is achieved using appropriate training or preamble sequence. Bypassing the noise dominated samples corresponding to the dead time allows the CDR 402 to maintain the sampling phase lock.

### Reconfigurable Power Meter, AGC and GSOP

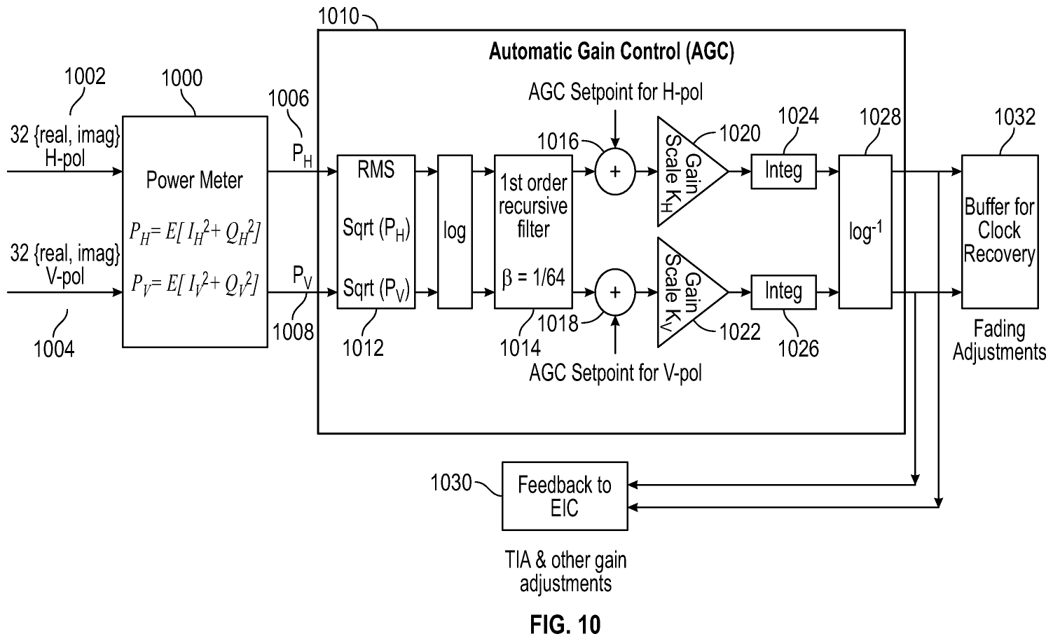

FIG. 10 illustrates a power meter and an automatic gain control 1000 processing according to some aspects. In FIG. 10, power meter 1000 can process a number of horizontal polarization samples 1002 and a number of vertical polarization samples 1004 (e.g., 32 samples) in each clock cycle generating a power measurement 1006, 1008 per polarization. AGC 1010 operations then follow with a Root mean square (rms) 1012 based approach. First order recursive filter 1014 can then filter the rms value, optionally in the log domain. AGC setpoints can be subtracted at points 1016, 1018. An error value is then scaled by a gain factor at blocks 1020, 1022, integrated at blocks 1024, 1026 and converted back to the linear domain at block 1028. These AGC gain adjustment values are fed back at 1030 to other electronics circuitry for trans-impedance amplifier (TIA) or other amplifier gain adjustments and in some examples can also be buffered at 1032 for improving Clock recovery performance in fading scenarios.

Gram-Schmidt orthogonalization procedures can be used to orthogonalize the in-phase (I) and quadrature (Q) signal components according to the following Equations (20-22):

$${r}_{I}^{ort} [ n ] = \frac{{r}_{I} [ n ]}{\sqrt{E \{ {r}_{I}^{2} [ n ]}} \text{?} \qquad ( 20 ) - ( 22 )$$

$${r}_{Q}^{int} [ n ] = {r}_{Q} [ n ] - \frac{E \{ {r}_{I} [ n ] {r}_{Q} [ n ] \} {r}_{I} [ n ]}{E \{ {r}_{I}^{2} [ n ] \}}$$

$${r}_{Q}^{ort} [ n ] = \frac{{r}_{Q}^{int} [ n ]}{\sqrt{E \{ {( {r}_{Q}^{int} [ n ] )}^{2} \}}}$$

$$\text{?} \text{indicates text missing or illegible when filed}$$

Where r_{I}^{ort} is an orthogonalized in-phase signal component, r_{Q}^{int} is a quadrature component before orthogonalization, and r_{Q}^{ort} is an orthogonalized quadrature component.

It can be noted that the denominators involve power calculations both using the in-phase and quadrature components over multiple samples, which is an opportunity to repurpose the power meter. In general, various baseband modules within modems according to example aspects require the power of a part or entire spectrum of the signal under consideration. In aspects, a programmable digital power meter can provide this power and additionally has built in support for providing instantaneous power value over a shorter averaging window.

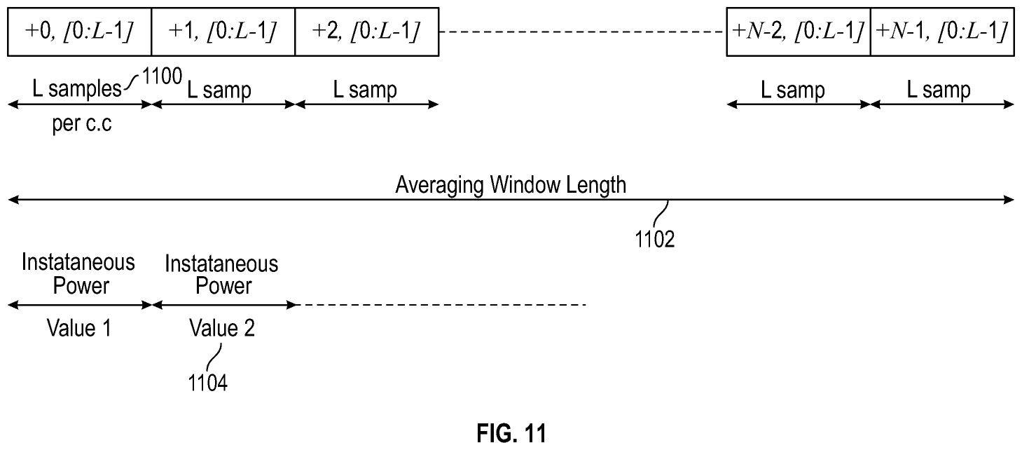

FIG. 11 illustrates a configurable averaging window according to some example aspects. In FIG. 11, L samples 1100 are shown as being processed on a per clock basis. The averaging window 1102 is set to be N clock cycles. In addition, the instantaneous power (power over a shorter window length) may also be configured, and this power is a set of values 1104 within the averaging window.

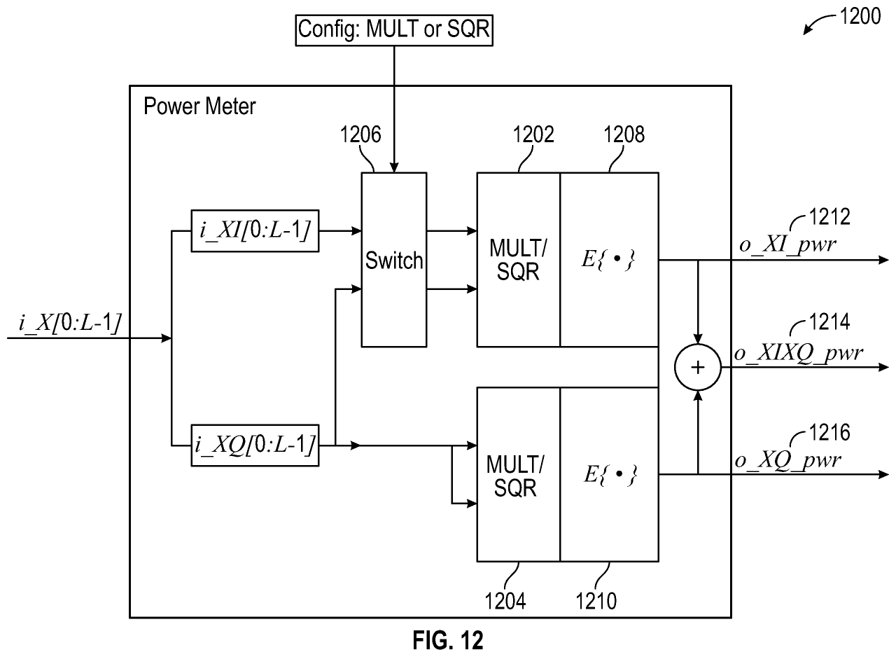

FIG. 12 is a block diagram of a power meter 1200 according to some aspects. Multiplier/squaring block 1202, 1204 can be provided at the input, wherein the input can include a same signal or two different signals and wherein a switch 1206 can switch being multiplying or squaring. Power can be calculated according to Equations (23)-(26):

E{r_{I}²[n]+r_{Q}²[n]} (23)

E{r_{Q}²[n]} (24)

E{r_{I}[n]*r_{Q}[n]} (25)

E{r_{I}²[n]} (26)

The multiplier/squaring blocks 1202, 1204 can be followed by an expectation operator (E{ }) 1208, 1210 that calculates the power that can be further combined. In Examples, output 1212 can be provided according to Equation (24), Output 1214 can be provided according to Equation (23) and output 1216 can be provided according to Equation (26).

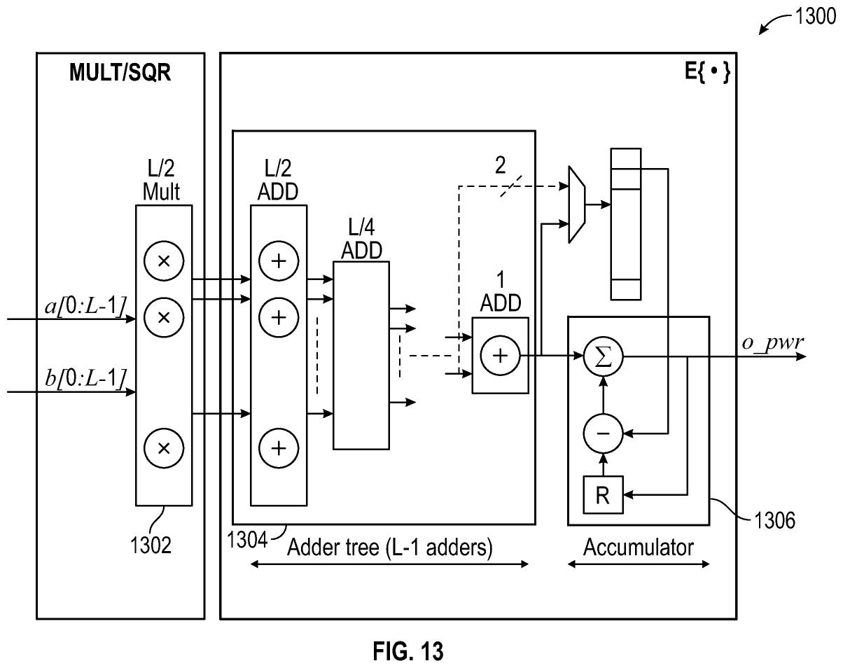

FIG. 13 is a block diagram of a programmable power meter 1300 according to some examples. In FIG. 13 multiplier tree 1302 and adder trees 1304 are followed by an accumulator 1306 that evaluates the power over a defined window while continuously saving the instantaneous power (over a shorter window) into a memory that can be accessed outside the power meter 1300.

### Other Systems and Apparatuses

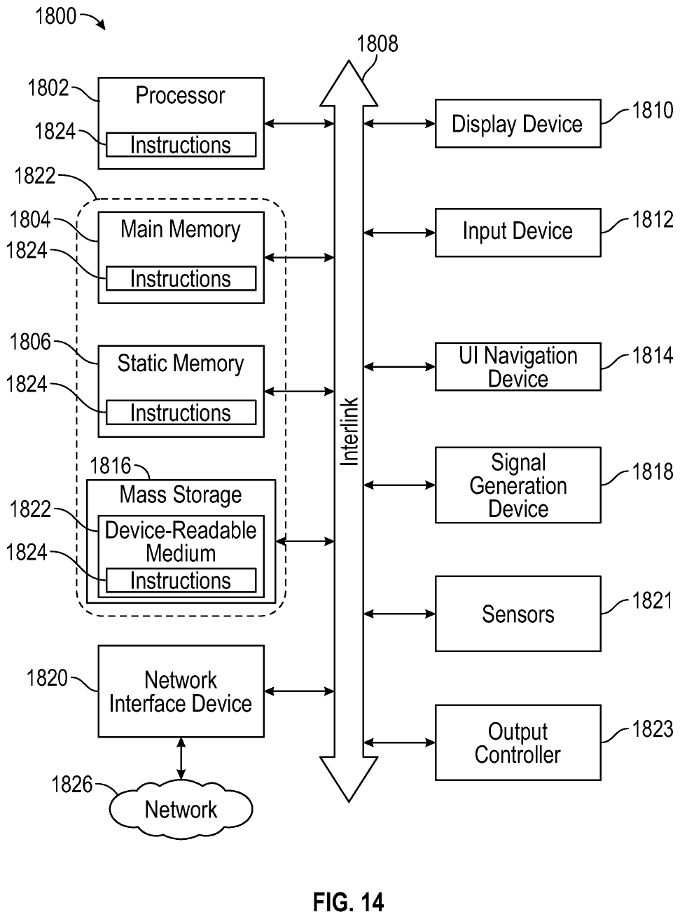

FIG. 14 illustrates a block diagram of a computing device 1800 that can be included in, for example, a satellite 102, 104 of FIG. 1, or of any control circuitry for controlling according to aspects described above, or for communicating with any of the satellites 102, 104. In alternative aspects, the communication device 1800 may operate as a standalone device or may be connected (e.g., networked) to other communication devices. In some aspects, the communication device 1800 can use one or more of the techniques and circuits discussed herein, in connection with any of FIG. 1-FIG. 13.

In several aspects, the methods, design and circuitry described are used in Coherent Optical Transceivers built for satellites to enable inter satellite optical links with high data rates of 100 Gbps or beyond.

In some aspects, inter satellite optical links refer to optical communication links between two satellites within the Low earth orbit (LEO) or between a Low earth orbit (LEO) satellite and a Geo-stationary earth orbit (GEO) satellite. Satellites may convey their ephemeris information to other satellites through suitable control interfaces. Ephemeris information may be in Two Line Elements (TLE) format with 5 parameters denoting the orbital plane parameters and 2 parameters denoting the satellite level parameters.

A Coherent optical transceiver may consist of a photonics circuitry, data converters, baseband DSP circuitry, FEC encoder and decoder, and a serial interface. Photonics circuitry is used to convert an electrical signal to an optical signal at the transmitter, and an optical signal to an electrical signal at the receiver. Photonics circuitry may further include a laser source both at the transmitter and the receiver. In coherent optical transceivers, the received optical signal is mixed with a local laser source to decode the signal, which enables both amplitude and phase modulation as well as polarization multiplexing. Data converter circuitry involves a Digital-to-Analog (DAC) converter at the transmitter and an Analog-to-Digital (ADC) converter at the receiver with appropriate sampling rates. Baseband DSP circuitry is used to modulate a signal at the transmitter and demodulate the signal at the receiver based on the waveform, standard and baud rates. Forward error correction (FEC) encoder at the transmitter and FEC decoder at the receiver helps in adding redundancy to reliably decode a bit stream. A serial bit interface is used to format, send or receive the bit stream at the transmitter and the receiver, respectively.

Photonics circuitry may use Mach-Zehnder modulators (MZM) at the transmitter to optically modulate the amplitude and phase based on the modulation scheme. At the transmitter, the photonics circuitry may send the signal either over a single mode fiber (SMF) or a polarization maintaining fiber (PMF) to the optical aperture, which transmits the laser signal over a free space channel. Photonics circuitry may use an Optical front-end with structures called Hybrid 90 at the receiver to mix the received optical signal with a local laser source and generate 4 streams of signals corresponding to the in-phase and quadrature components for the two polarizations. These 4 signals may then be fed to balanced photodiodes for photodetection and amplified further by a Trans-Impedance Amplifier (TIA). ADC circuitry may then convert the analog signal to digital for baseband processing.

Laser source may be tunable in the C-band wavelength range of 1530-1565 nm corresponding to frequency range of roughly 191-196 THz.

Baseband DSP circuitry may support waveforms according to various optical standards such as i) OpenZR+ standard used in fiber optic systems with dual polarization and modulation schemes such as QPSK, 8QAM and 16QAM, ii) Digital Video Broadcasting standard DVB-S2 with several modulation schemes, iii) NASA developed standard for Lunar Communication Relay Demonstration (LCRD) employing a custom Differential PSK (DPSK) waveform with DVB-S2 FEC, iv) Space Development Agency (SDA) standard with OOK based modulation schemes.

Circuitry (e.g., processing circuitry) is a collection of circuits implemented in tangible entities of the device 1800 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation.

In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the device 1800 follow.

In some aspects, the device 1800 may operate as a standalone device or may be connected (e.g., networked) to other devices. In a networked deployment, the communication device 1800 may operate in the capacity of a server communication device, a client communication device, or both in server-client network environments. In an example, the communication device 1800 may act as a peer communication device in peer-to-peer (P2P) (or other distributed) network environment. The communication device 1800 may be a UE, eNB, PC, a tablet PC, a STB, a PDA, a mobile telephone, a smart phone, a web appliance, a network router, switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a communication device-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Computing device 1800 may include a hardware processor 1802 (e.g., a central processing unit (CPU), a graphics processing unit (GPU), a hardware processor core, or any combination thereof), a main memory 1804, a static memory 1806, and mass storage device 1816 (e.g., hard drive, tape drive, flash storage, or other block or storage devices), some or all of which may communicate with each other via an interlink (e.g., bus) 1808.

The communication device 1800 may further include a display unit 1810, an alphanumeric input device 1812 (e.g., a keyboard), and a user interface (UI) navigation device 1814 (e.g., a mouse). In an example, the display unit 1810, input device 1812 and UI navigation device 1814 may be a touch screen display. The communication device 1800 may additionally include a signal generation device 1818 (e.g., a speaker), a network interface device 1820, and one or more sensors 1821, such as a global positioning system (GPS) sensor, compass, accelerometer, or another sensor. The communication device 1800 may include an output controller 1823, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device 1816 may include a communication device-readable medium 1822, on which is stored one or more sets of data structures or instructions 1824 (e.g., software) embodying or utilized by any one or more of the techniques or functions described herein. In some aspects, registers of the processor 1802, the main memory 1804, the static memory 1806, and/or the mass storage device 1816 may be, or include (completely or at least partially), the device-readable medium 1822, on which is stored the one or more sets of data structures or instructions 1824, embodying or utilized by any one or more of the techniques or functions described herein. In an example, one or any combination of the hardware processor 1802, the main memory 1804, the static memory 1806, or the mass storage device 1816 may constitute the device-readable medium 1822.

As used herein, the term “device-readable medium” is interchangeable with “computer-readable medium” or “machine-readable medium.” While the communication device-readable medium 1822 is illustrated as a single medium, the term “communication device-readable medium” may include a single medium or multiple media (e.g., a centralized or distributed database, and/or associated caches and servers) configured to store the one or more instructions 1824.

The term “communication device-readable medium” may include any medium that is capable of storing, encoding, or carrying instructions for execution by the communication device 1800 and that cause the communication device 1800 to perform any one or more of the techniques of the present disclosure, or that is capable of storing, encoding, or carrying data structures used by or associated with such instructions. Non-limiting communication device-readable medium examples may include solid-state memories, and optical and magnetic media. Specific examples of communication device-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device-readable media may include non-transitory communication device-readable media. In some examples, communication device-readable media may include communication device-readable media that is not a transitory propagating signal.

The instructions 1824 may further be transmitted or received over a communications network 1826 using a transmission medium via the network interface device 1820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 1820 may include one or more physical jacks (e.g., Ethernet, coaxial, or phone jacks) or one or more antennas to connect to the communications network 1826. In an example, the network interface device 1820 may include a plurality of antennas to wirelessly communicate using at least one of single-input multiple-output (SIMO), MIMO, or multiple-input single-output (MISO) techniques. In some examples, the network interface device 1820 may wirelessly communicate using Multiple User MIMO techniques.

The term “transmission medium” shall be taken to include any intangible medium that is capable of storing, encoding, or carrying instructions for execution by the communication device 1800, and includes digital or analog communications signals or other intangible medium to facilitate communication of such software. In this regard, a transmission medium in the context of this disclosure is a device-readable medium.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “an example aspect,” “some aspects,” “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

The term “optical system”, as used herein, includes, for example, a device capable for optical communication, by modulating a signal using a laser source or visible light, involving transmission of optical pulses, and may include coherent or direct detection, incorporating photon counting methods or baseband circuitry for signal processing.

As used herein, unless otherwise specified the use of the ordinal adjectives “first”, “second”, “third” etc., to describe a common object, merely indicate that different instances of like objects are being referred to and are not intended to imply that the objects so described must be in a given sequence, either temporally, spatially, in ranking, or in any other manner.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that is integrated with a computer, or a peripheral that is attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting and/or the action of receiving. In one example, the phrase “communicating a signal” may refer to the action of transmitting the signal by a first device and may not necessarily include the action of receiving the signal by a second device. In another example, the phrase “communicating a signal” may refer to the action of receiving the signal by a first device and may not necessarily include the action of transmitting the signal by a second device.

Some demonstrative aspects may be used in conjunction with a wireless communication network communicating over a frequency band above 45 Gigahertz (GHz), e.g., 60 GHz. However, other aspects may be implemented utilizing any other suitable wireless communication frequency bands, for example, an Extremely High Frequency (EHF) band (the millimeter wave (mmWave) frequency band), e.g., a frequency band within the frequency band of between 20 GHz and 300 GHz, a frequency band above 45 GHz, a frequency band below 20 GHz, e.g., a Sub 1 GHz (S1G) band, a 2.4 GHz band, a 5 GHz band, a WLAN frequency band, a WPAN frequency band, a frequency band according to the WGA specification, and the like.

As used herein, the term “circuitry” may, for example, refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, circuitry may include logic, at least partially operable in hardware. In some aspects, the circuitry may be implemented as part of and/or in the form of a radio virtual machine (RVM), for example, as part of a Radio processor (RP) configured to execute code to configured one or more operations and/or functionalities of one or more radio components.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “antenna” or “antenna array,” as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

### ADDITIONAL NOTES AND ASPECTS

Example 1 is a clock data recovery (CDR) apparatus based on a feedback digital phase locked loop (D-PLL) mechanism, comprising: an interpolator circuitry to interpolate an input received signal and to generate an output signal removing the sampling clock offsets; timing error detector (TED) circuitry coupled to process the output signal and to provide a timing error as feedback to the interpolator circuitry, the timing error being adjusted by gain factors used in at least one of an automatic gain control (AGC) circuitry and an orthogonalization circuitry; loop filter (LF) circuitry to filter the timing error to remove noise effects; and numerically controlled oscillator (NCO) circuitry to adjust for a basepoint and fractional interval used to adjust resampling coefficients within the interpolator circuitry.

In Example 2, the subject matter of Example 1 can optionally include wherein the TED circuitry comprises a Gardner TED or modified power based variants within a Gardner family of TED having an oversampling factor of 2, with three consecutive T/2 spaced samples being used to calculate the timing error, wherein T is a symbol period.

In Example 3, the subject matter of any of Examples 1-2 can optionally include wherein the TED circuitry comprises an Amplitude directed TED having an oversampling factor of 2 and three consecutive T/2 spaced samples, wherein the TED circuitry is configured to perform a signum operation to remove a magnitude in the received signal when calculating a sampling phase or the timing error in the received signal.

In Example 4, the subject matter of any of Examples 1-3 can optionally include wherein loop filter bandwidth is adaptively calculated and configured based on a filtered noise measured using an error metric from an adaptive equalizer, wherein filtered error metrics can include at least one of a constant modulus algorithm (CMA), a least mean-squares (LMS), radius directed equalizer (RDE), feed-forward equalizer (FFE) or a decision feedback equalizer (DFE), and wherein loop filter parameters including at least one of natural frequency, proportional gains, or integral gains are calculated based on loop filter bandwidth adjusted using a noise measure fed back from one or more of the adaptive equalizers such as CMA, LMS, RDE, FFE or DFE.

In Example 5, the subject matter of any of Examples 1-4 can optionally include wherein the loop filter circuitry is configured to adapt between first order and second order modes of operation either by turning an integrator on or off, or by setting a digital coefficient, and wherein the loop filter circuitry is configured in a first order mode of operation during initial acquisition and subsequently configured in a second order mode of operation.

In Example 6, the subject matter of any of Examples 1-5 can optionally include wherein the AGC procedure comprises at least one of a feed-forward mechanism or a feedback mechanism, and wherein the AGC procedure uses detectors based on at least one of a true root mean square (RMS) detector, an envelope detector, a square law detector or a log detector, with a programmable AGC loop bandwidth, and wherein AGC gain values are buffered in a dedicated memory for a duration, the duration being based on a latency.

In Example 7, the subject matter of any of Examples 1-6 can optionally include wherein the orthogonalization circuitry is based on at least one of a Gram-Schmidt Orthogonalization procedure (GSOP) or a Symmetric Lowdin Orthogonalization procedure, and wherein gain factors from the orthogonalization procedure are used for re-normalization of the TED output, and wherein the orthogonalization procedure gain factors are buffered in a dedicated memory for a duration, the duration determined based on a latency incurred due to signal processing circuitry between the GSOP or Lowdin circuitry and the CDR circuitry.

In Example 8, the subject matter of any of Examples 1-7 can optionally include wherein the TED circuitry is configured based on an edge detection method for power correlation to identify symbol boundaries and correct the sampling clock offset, wherein demodulated symbols are used to calculate the timing error in the edge detection method.

In Example 9, the subject matter of any of Examples 1-8 can optionally include wherein parameters of the TED circuitry and LF circuitry parameters are configured based on a rolloff factor of a root raised cosine (RRC) filter.

In Example 10, the subject matter of any of Examples 1-9 can optionally include wherein the input received signal includes a resampled signal at an integer multiple ‘N’ of a baud rate of a waveform the input received signal, and wherein a signal oversampling factor N is in a range of 2-8.

In Example 11, the subject matter of any of Examples 1-10 can optionally include gating circuitry to prevent the input signal samples from being processed, and wherein the gating circuitry identifies a dead time with no signal transmission based on a frame synchronizer circuitry.

In Example 12, the subject matter of any of Examples 1-11 can optionally include wherein the timing error detector (TED) circuitry is coupled to process an equalized signal provided by an adaptive equalizer and to provide the timing error as feedback to the interpolator circuitry, the timing error being adjusted by at least one of an automatic gain control (AGC) procedure and an orthogonalization procedure, wherein the equalizer circuitry is based on at least one of constant modulus algorithm (CMA), least mean-squares (LMS), radius directed equalizer (RDE), feed-forward equalizer (FFE) or decision Feedback equalizer (DFE).

In Example 13, the subject matter of any of Examples 1-12 can optionally include buffer circuitry to buffer and feedback filtered sampling phase or timing errors after a TED and a Loop filter, from digital signal processor (DSP) circuitry to analog-to-digital converter (ADC) circuitry; and a Voltage Controlled Oscillator (VCO) to adjust the sampling phase within the ADC circuitry; and wherein an output of the CDR apparatus has sampling clock offsets corrected in the received signal through the continuous sampling phase adjustments made in the ADCs.

Example 14 is a digital power meter apparatus configured to: measure received power in a signal per clock cycle with a configurable averaging window to generate power measurements, the power measurements corresponding to at least one of in-phase or quadrature components of the signal or correlation between the in-phase and the quadrature component of the signal.

In Example 15, the subject matter of Example 14 can optionally include an output to provide power meter measurements to Automatic Gain Control (AGC) circuitry.

In Example 16, the subject matter of any of Examples 14-15 can optionally include orthogonalization circuitry, and wherein the digital power meter is configured to calculate scaling factors for the orthogonalization circuitry, the scaling factors including at least one of power in the in-phase and quadrature components or correlation between the in-phase and quadrature components.

In Example 17, the subject matter of any of Examples 14-16 can optionally include a Clock Data Recovery (CDR) apparatus, and wherein the apparatus is included in a modem for optical inter-satellite links, and CDR parameters and power meter parameters are designed based on a fading model due to dynamic pointing jitter, the model including channel coherence time, fading distribution and fade levels.

Example 18 is a computer-readable medium comprising instructions that, when executed on processing circuitry, cause the processing circuitry to execute clock and data recovery operations including: interpolating an input received signal to generate an output signal with sampling clock offsets corrected; timing error detection (TED) coupled to process the output signal and to provide a timing error as feedback to the interpolator, the timing error being adjusted or re-normalized by at least one of an automatic gain control (AGC) procedure and an orthogonalization procedure in order to handle fading; filtering the timing error using a loop filter (LF) to remove noise effects; and adjust for a basepoint and fractional interval using a numerically controlled oscillator (NCO) to adjust resampling coefficients within the interpolator.

In Example 19, the subject matter of Example 18 can optionally include wherein the TED comprises a Gardner TED or modified power based variants within a Gardner family of TED involving oversampling factor of 2, with three consecutive T/2 spaced samples being used to calculate the timing error, wherein T is a symbol period.

In Example 20, the subject matter of any of Examples 18-19 can optionally include wherein loop filter bandwidth is adaptively calculated and configured based on a filtered noise measured using an error metric from an adaptive equalizer, wherein filtered error metrics can include at least one of a constant modulus algorithm (CMA), a least mean-squares (LMS), radius directed equalizer (RDE), feed-forward equalizer (FFE) or a decision feedback equalizer (DFE), and wherein loop filter parameters including at least one of natural frequency, proportional gains, or integral gains are calculated based on loop filter bandwidth adjusted using a noise measure fed back from the equalizers.

In Example 21, the subject matter of any of Examples 18-20 can optionally include instructions that, when executed on processing circuitry, cause the processing circuitry to: buffer and feedback filtered sampling phase or timing errors after a TED and a Loop filter, from digital signal processor (DSP) to analog-to-digital converter (ADC); a Voltage Controlled Oscillator (VCO) to adjust the sampling phase within the ADC; and wherein an output of the CDR apparatus has sampling clock offsets corrected in the received signal through the continuous sampling phase adjustments made in the ADCs.

Example 22 is a method for clock data recovery, the method comprising: interpolating an input received signal to generate an output signal with sampling clock offsets corrected; processing the output signal and to provide a timing error as feedback to the interpolator, the timing error being adjusted or re-normalized by at least one of an automatic gain control (AGC) procedure and an orthogonalization procedure in order to handle fading; filtering the timing error to remove noise effects; and adjusting for a basepoint and fractional interval used to adjust resampling coefficients for the interpolating.

The above detailed description includes references to the accompanying drawings, which form a part of the detailed description. The drawings show, by way of illustration, specific aspects in which the invention can be practiced. These aspects are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other aspects can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed aspect. Thus, the following claims are hereby incorporated into the Detailed Description, with each claim standing on its own as a separate aspect, and it is contemplated that such aspects can be combined with each other in various combinations or permutations. The scope of the invention should be determined with reference to the appended claims, along with the full scope of equivalents to which such claims are legally entitled.

We claim:

1. A clock data recovery (CDR) apparatus based on a feedback digital phase locked loop (D-PLL) mechanism, comprising:
an interpolator circuitry to interpolate an input received signal and to generate an output signal removing the sampling clock offsets;
timing error detector (TED) circuitry coupled to process the output signal and to provide a timing error as feedback to the interpolator circuitry, the timing error being adjusted by gain factors used in at least one of an automatic gain control (AGC) circuitry and an orthogonalization circuitry;
loop filter (LF) circuitry to filter the timing error to remove noise effects; and
numerically controlled oscillator (NCO) circuitry to adjust for a basepoint and fractional interval used to adjust resampling coefficients within the interpolator circuitry.

2. The CDR apparatus of claim 1, wherein the TED circuitry comprises a Gardner TED or modified power based variants within a Gardner family of TED having an oversampling factor of 2, with three consecutive T/2 spaced samples being used to calculate the timing error, wherein T is a symbol period.

3. The CDR apparatus of claim 1, wherein the TED circuitry comprises an Amplitude directed TED having an oversampling factor of 2 and three consecutive T/2 spaced samples, wherein the TED circuitry is configured to perform a signum operation to remove a magnitude in the received signal when calculating a sampling phase or the timing error in the received signal.

4. The CDR apparatus of claim 1, wherein loop filter bandwidth is adaptively calculated and configured based on a filtered noise measured using an error metric from an adaptive equalizer, wherein filtered error metrics can include at least one of a constant modulus algorithm (CMA), a least mean-squares (LMS), radius directed equalizer (RDE), feed-forward equalizer (FFE) or a decision feedback equalizer (DFE), and wherein loop filter parameters including at least one of natural frequency, proportional gains, or integral gains are calculated based on loop filter bandwidth adjusted using a noise measure fed back from one or more of the adaptive equalizers such as CMA, LMS, RDE, FFE or DFE.

5. The CDR apparatus of claim 1, wherein the loop filter circuitry is configured to adapt between first order and second order modes of operation either by turning an integrator on or off, or by setting a digital coefficient, and wherein the loop filter circuitry is configured in a first order mode of operation during initial acquisition and subsequently configured in a second order mode of operation.

6. The CDR apparatus of claim 1, wherein the AGC procedure comprises at least one of a feed-forward mechanism or a feedback mechanism, and wherein the AGC procedure uses detectors based on at least one of a true root mean square (RMS) detector, an envelope detector, a square law detector or a log detector, with a programmable AGC loop bandwidth, and wherein AGC gain values are buffered in a dedicated memory for a duration, the duration being based on a latency.

7. The CDR apparatus of claim 1, wherein the orthogonalization circuitry is based on at least one of a Gram-Schmidt Orthogonalization procedure (GSOP) or a Symmetric Lowdin Orthogonalization procedure, and wherein gain factors from the orthogonalization procedure are used for re-normalization of the TED output, and wherein the orthogonalization procedure gain factors are buffered in a dedicated memory for a duration, the duration determined based on a latency incurred due to signal processing circuitry between the GSOP or Lowdin circuitry and the CDR circuitry.

8. The CDR apparatus of claim 1, wherein the TED circuitry is configured based on an edge detection method for power correlation to identify symbol boundaries and correct the sampling clock offset, wherein demodulated symbols are used to calculate the timing error in the edge detection method.

9. The CDR apparatus of claim 1, wherein parameters of the TED circuitry and LF circuitry parameters are configured based on a rolloff factor of a root raised cosine (RRC) filter.

10. The CDR apparatus of claim 1, wherein the input received signal includes a resampled signal at an integer multiple ‘N’ of a baud rate of a waveform the input received signal, and wherein a signal oversampling factor N is in a range of 2-8.

11. The CDR apparatus of claim 1, further comprising gating circuitry to prevent the input signal samples from being processed, and wherein the gating circuitry identifies a dead time with no signal transmission based on a frame synchronizer circuitry.

12. The CDR apparatus of claim 1, wherein the timing error detector (TED) circuitry is coupled to process an equalized signal provided by an adaptive equalizer and to provide the timing error as feedback to the interpolator circuitry, the timing error being adjusted by at least one of an automatic gain control (AGC) procedure and an orthogonalization procedure, wherein the equalizer circuitry is based on at least one of constant modulus algorithm (CMA), least mean-squares (LMS), radius directed equalizer (RDE), feed-forward equalizer (FFE) or decision Feedback equalizer (DFE).

13. The CDR apparatus of claim 1, further comprising:
buffer circuitry to buffer and feedback filtered sampling phase or timing errors after a TED and a Loop filter, from digital signal processor (DSP) circuitry to analog-to-digital converter (ADC) circuitry; and
a Voltage Controlled Oscillator (VCO) to adjust the sampling phase within the ADC circuitry; and wherein an output of the CDR apparatus has sampling clock offsets corrected in the received signal through the continuous sampling phase adjustments made in the ADCs.

14. A digital power meter apparatus, the apparatus configured to:
measure received power in a signal per clock cycle with a configurable averaging window to generate power measurements, the power measurements corresponding to at least one of in-phase or quadrature components of the signal or correlation between the in-phase and the quadrature component of the signal.

15. The digital power meter apparatus of claim 14, further comprising an output to provide power meter measurements to Automatic Gain Control (AGC) circuitry.

16. The digital power meter of claim 14, further comprising orthogonalization circuitry, and wherein the digital power meter is configured to calculate scaling factors for the orthogonalization circuitry, the scaling factors including at least one of power in the in-phase and quadrature components or correlation between the in-phase and quadrature components.

17. The apparatus of claim 14, further comprising a Clock Data Recovery (CDR) apparatus and wherein:
the apparatus is included in a modem for optical inter-satellite links, and CDR parameters and power meter parameters are designed based on a fading model due to dynamic pointing jitter, the model including channel coherence time, fading distribution and fade levels.

18. A computer-readable medium comprising instructions that, when executed on processing circuitry, cause the processing circuitry to execute clock and data recovery operations including:
interpolating an input received signal to generate an output signal with sampling clock offsets corrected;
timing error detection (TED) coupled to process the output signal and to provide a timing error as feedback to the interpolator, the timing error being adjusted or re-normalized by at least one of an automatic gain control (AGC) procedure and an orthogonalization procedure in order to handle fading;
filtering the timing error using a loop filter (LF) to remove noise effects; and
adjust for a basepoint and fractional interval using a numerically controlled oscillator (NCO) to adjust resampling coefficients within the interpolator.

19. The computer readable medium of claim 18, wherein the TED comprises a Gardner TED or modified power based variants within a Gardner family of TED involving oversampling factor of 2, with three consecutive T/2 spaced samples being used to calculate the timing error, wherein T is a symbol period.

20. The computer readable medium of claim 18, wherein loop filter bandwidth is adaptively calculated and configured based on a filtered noise measured using an error metric from an adaptive equalizer, wherein filtered error metrics can include at least one of a constant modulus algorithm (CMA), a least mean-squares (LMS), radius directed equalizer (RDE), feed-forward equalizer (FFE) or a decision feedback equalizer (DFE), and wherein loop filter parameters including at least one of natural frequency, proportional gains, or integral gains are calculated based on loop filter bandwidth adjusted using a noise measure fed back from the equalizers.

21. A computer-readable medium of claim 18 comprising instructions that, when executed on processing circuitry, cause the processing circuitry to:
buffer and feedback filtered sampling phase or timing errors after a TED and a Loop filter, from digital signal processor (DSP) to analog-to-digital converter (ADC); and
adjust the sampling phase within the ADC; and wherein an output includes sampling clock offsets corrected in the received signal through the continuous sampling phase adjustments made in the ADCs.

22. A method for clock data recovery, the method comprising a feedback digital phase locked loop (D-PLL) mechanism, comprising:
interpolating an input received signal to generate an output signal with sampling clock offsets corrected;
processing the output signal and to provide a timing error as feedback to the interpolator, the timing error being adjusted or re-normalized by at least one of an automatic gain control (AGC) procedure and an orthogonalization procedure in order to handle fading;
filtering the timing error to remove noise effects; and
adjusting for a basepoint and fractional interval used to adjust resampling coefficients for the interpolating.

23. The method of claim 22, wherein providing the timing error comprises performing an Amplitude directed timing error detection involving and oversampling factor of 2 and with three consecutive T/2 spaced samples, wherein the method is configured to perform a signum operation to remove a magnitude in the samples when calculating the sampling phase or timing error in the received signal.

24. The method of claim 22, wherein the AGC is based on a feed-forward mechanism or a feedback mechanism, and uses detectors based on at least one of a true root mean square (RMS) detector, an envelope detector, a square law detector or a log detector, with a programmable AGC loop bandwidth, and wherein AGC gain values are buffered in a dedicated memory for a duration, based on a latency incurred due to signal processing between the AGC and the CDR.

25. The method of claim 22, wherein the filtering includes adapting between a first order mode and a second order mode of operation either by turning an integrator on or off, or by setting a digital coefficient, and wherein filtering is performed in the first order mode of operation during initial acquisition for fast clock recovery and later configured in the second order mode of operation.
